(19) United States
(12) Patent Application Publication
(10) Pub. No.: US 2022/0021547 A1
(43) Pub. Date: Jan. 20, 2022

(54) DIGITAL METHOD FOR CONTROLLING ACCESS TO AN OBJECT, A RESOURCE OR SERVICE BY A USER

(71) Applicant: In-Webo Technologies SAS, Paris (FR)

(72) Inventor: Didier Perrot, San Francisco, CA (US)

(21) Appl. No.: 16/980,352

(22) PCT Filed: Oct. 17, 2018
(86) PCT No.: PCT/EP2018/025268

§ 371 Date: Oct. 12, 2021

(30) Foreign Application Priority Data
Nov. 23, 2017 (FR) 1761094

(51) Int. Cl. H04L 9/32; G07C 9/00; H04L 9/08

(52) U.S. Cl. CPC H04L 9/3273; G07C 2009/00388; H04L 9/0825; G07C 9/00309

(57) ABSTRACT

Controlling access to an object or service by a user by a smart lock access control device involves sending by the smart lock to a virtual key a message comprising: the identifier of the smart lock (Lock-ID); a challenge (Ch1) created by the smart lock; the signature by the private key of the smart lock (Klock-priv) of information related to the identifier of the smart lock (Lock-ID) and challenge (Ch1); and the level of interaction required among at least two levels of interaction. The method verifies by the virtual key that the smart lock is known to it by comparison of the smart lock identifier received to that stored by the virtual key, validates by the virtual key of the signature by using the public key of the smart lock (Klock-pub); and, if the validation is positive, selects and implements the level of interaction received by the virtual key; and after validation of the interaction by the virtual key, and send a message by the virtual key to the smart lock comprising: the identifier of the virtual key (Key-ID); and a first opening key depending on the challenge received (Ch1) and the information (Kv1) contained in the virtual key; so that if the smart lock validates the opening key, it gives access to the object or service with the access level associated with the interaction level used.

### CROSS REFERENCE TO RELATED APPLICATIONS

This patent application is related, and claims priority, to PCT application PCT/EP20 18/025268, filed Oct. 17, 2018, entitled “DIGITAL METHOD FOR CONTROLLING ACCESS TO AN OBJECT, A RESOURCE OR SERVICE BY A USER”, which claims the priority to French Patent Application No. 1761094, filed Nov. 23, 2017, entitled “DIGITAL PROCESS FOR CONTROL OF ACCESS TO AN OBJECT, RESOURCE OR SERVICE BY A USER,” the entire contents of which are incorporated herein by reference.

### TECHNICAL FIELD

The present invention relates to a digital method for controlling access to an object, a resource or a service by a user, access being controlled by an access control device known as smart lock and the user having a digital device called virtual key.

### BACKGROUND

The initial Internet connects nodes of the network between them, computers and servers. The Internet of Things (IoT) extends these connections to embedded electronics for consumer and industrial objects, in the home, transport, car, health, city, infrastructure, etc.

The problems of computer security present in the initial Internet also affect the Internet of Things, probably more tangibly since the Internet of Things is becoming more and more confused with the physical world.

A particular area of security, access control, aims to allow only legitimate users—people, even processes—in the context of their own authorization. For this, systems and objects embark or communicate with a system of authorization via a private communication network, and more and more often a public one (Internet).

At the request of a user, the authorization system first verifies by means of an identification process that it is an authorized user and, if so, what are his or her rights. Access control for most web applications works like this. Other systems, however, especially when they are not constantly connected, may not know their users and must then verify that anonymous users who present themselves have the rights they claim. Examples of these latter systems include “shared” objects—that is to say, not having a given set of users—such as vehicles (autonomous or not), locks or electronic locks equipping doors or other objects, parking meters, control systems in ticketing, electronic payment terminals, etc.

Controlling access to shared or non-constantly connected objects such as those listed above poses a number of difficulties, particularly in terms of security, that conventional methods—such as strong authentication used in the context of sensitive web applications—do not solve users. One of these difficult aspects concerns the non-falsification of the rights that the user claims to have and that the object may not know beforehand. Another of these difficult aspects is to counter the attempts of attack or theft of the object without complicating the task of the legitimate user. The rights of the user are indeed generally dematerialized on a support such as a smartphone from where they can be extracted via a targeted attack or spyware; these rights can also be eavesdropped and copied when the user's device and the object communicate via an unprotected communication channel, which is by default the case in the examples mentioned previously.

For these reasons, it would be beneficial to have a method allowing secure access control, simple and non-blocking, for shared objects not necessarily constantly connected. Having a secure access control that does not require permanent Internet or mobile connectivity would also reduce the cost of designing, manufacturing, or operating such objects.

### BRIEF DESCRIPTION OF THE DRAWINGS

The invention will be better understood by reading the description which follows, given solely by way of example, and with reference to the appended figures in which:

FIG. 1 represents the constituents of a virtual key and of a smart lock according to one embodiment of the invention; and

FIG. 2 represents the flow of information and processing exchange during one embodiment of the invention.

### WRITTEN DESCRIPTION

To solve one or more of the aforementioned drawbacks, according to embodiments of the invention, a digital method is provided for controlling access to an object or service by a user, said access to said object or service being controlled by a smart lock access control device (1) comprising a digital communication means (3), a computer (5), a lock (7) for unlocking access to the object or service and a storage memory (9) containing an identifier of the smart lock (Lock-ID), a key pair for asymmetric cryptography (Klock-priv, Klock-pub) and the user having a digital device called virtual key (11) comprising a communication means (13) adapted to communicate with the communication means of the smart lock, a calculator (15) and a storage memory (17) containing an identifier of the virtual key (Key-ID), the identifier (Lock-ID) and the public key (Klock-pub) of the smart lock with which is associated the virtual key and a first information (Kv1) obtained as a result of the signature by the private key (Klock-priv) of the identifiers of the virtual key and of the smart lock (Key-ID, Lock-ID) and an arbitrary parameter (Misc1), the lock of the smart lock comprising at least two levels of access to the object or service associated with two levels of interaction between the virtual key and the user, a first level associated with an implicit interaction by simply having a communication between the communication means of the virtual key and of the smart lock and a second level associated with an interaction with explicit validation of the user, said method comprising:

sending by the smart lock to the virtual key a message comprising:

i. the identifier of the smart lock (Lock-ID);

ii. a challenge (Ch1) created by the smart lock;

iii. the signature by the private key of the smart lock (Klock-priv) of information related to the identifier of the smart lock (Lock-ID) and challenge (Ch1); and

iv. the level of interaction required among at least two levels of interaction;

verification by the virtual key that the smart lock is known to it by comparison of the smart lock identifier received to that stored by the virtual key;

validation by the virtual key of the signature by using the public key of the smart lock (Klock-pub); and, if the validation is positive,

selection and implementation of the level of interaction received by the virtual key; and after validation of the interaction by the virtual key;

Sending a message by the virtual key to the smart lock comprising:

i. the identifier of the virtual key (Key-ID); and

ii. A first opening key depending on the challenge received (Ch1) and the information (Kv1) contained in the virtual key; so that

If the smart lock validates the opening key, it gives access to the object or service with the access level associated with the interaction level used.

Thus, advantageously, the method makes it possible to issue and verify securely access requests for a smart lock and a context, without the smart lock necessarily containing any information about the virtual key or its carrier, whether or not this smart lock is connected to a communication network.

Particular features or embodiments of the invention, usable alone or in combination, are:

The virtual key contains a second information constructed as the first information but with a separate arbitrary parameter, each information being associated with a type of interaction;

A third level of access to the object or service is defined and associated with a level of interaction requiring user (carrier) identification, and in that the virtual key furthermore comprises a third piece of encrypted information obtained by the encryption of a third piece of information constructed in the same way as the first information but with a separate arbitrary parameter, the encryption being effected by an encryption key derived from a secret code associated with the user, the method further comprising that, when interacting with the user, the virtual key calculates a decryption key similar to the encryption key and the message sent by the virtual key after the interaction validation step further comprises a second opening key obtained by decrypting the third information encrypted by the decryption key and the smart lock also validates the second opening key before allowing access to the product or service;

The virtual key furthermore comprises context information resulting from the signature of the identifier of the virtual key and of a parameter summarizing the access rights associated with the virtual key by the private key of the smart lock, this context information being transmitted by the virtual key to the smart lock, so that the smart lock validates the integrity of the context information before allowing access to the product or service;

The parameter is generated by a hash function having as input a usage context description XML file; and/or

The smart lock includes a revocation list containing the identifiers of the virtual keys for which no access authorization is possible.

Another aspect of embodiments of the invention relates to a computer program downloadable from a communication network and/or recorded on a computer-readable and/or executable medium by a processor, which includes program code instructions for the implementation of the method as defined above during a program execution by a computing unit of said apparatus.

A third aspect of embodiments of the invention relates to a digital access control device said a smart lock for access to an object or service by a user, comprising a digital communication means, a computer, a software or electronic or hardware lock to unlock the access to the object or service and a storage memory containing an identifier of the smart lock, a key pair for asymmetric cryptography, and being adapted to communicate with a digital device called virtual key comprising a communication means adapted to communicate with the communication means of the smart lock, a computer and a storage memory containing an identifier of the virtual key, the identifier and the public key of the smart lock with which the virtual key is associated and a first information obtained by the signature by the private key of the identifiers of the virtual key and of the smart lock and of an arbitrary parameter, the lock of the smart lock comprising at least 2 levels of access to the object or service associated with 2 levels of interaction between the virtual key and the user, a first level associated with an implicit interaction by simply setting a communication between the means of communication of the virtual key and of the smart lock and a second level associated with an interaction with explicit validation of the user, said access control device being adapted to:

Send to the virtual key a message including:

the identifier of the smart lock;

a challenge created by the smart lock;

the signature by the private key of the smart lock of information related to the identifier of the smart lock and the challenge; and

the level of interaction required among at least two levels of interaction;

Receive a message from the virtual key including:

the identifier of the virtual key; and

A first opening key depending on the challenge received and the information contained in the virtual key; so that,

if the opening key is validated, give access to the object or service with the access level associated with the interaction level used.

A fourth aspect of embodiments of the invention relates to a digital access device said a virtual key adapted to communicate with an access control device said a smart lock comprising a means of digital communication, a calculator, a lock for unlocking access to the object or service and a storage memory containing an identifier of the smart lock, a key pair for asymmetric cryptography, said virtual key comprising a communication means adapted to communicate with the communication means of the smart lock, a computer and a storage memory containing an identifier of the virtual key, the identifier and the public key of the smart lock with which the virtual key is associated and a first information obtained by signing with the private key the virtual key and smart lock identifiers and an arbitrary parameter, the lock of the smart lock comprising at least 2 levels of access to the object or service associated with 2 levels of interaction between the virtual key and the user, a first level associated with an implicit interaction by simply putting in communication the means of communication of the virtual key and of the smart lock and a second level associated with an interaction involving the explicit validation of the user, said virtual key being adapted for:

Receive from the smart lock a message including:

the identifier of the smart lock;

a challenge created by the smart lock;

The signature by the private key of the smart lock of an information related to the identifier of the lock and the challenge; and

the level of interaction required among at least two levels of interaction;

verify that the smart lock is known by comparison of the smart lock identifier received with that stored by the virtual key;

validate the signature by using the public key of the smart lock; and, if the validation is positive;

select and implement the level of interaction received by the virtual key; and after validation of the interaction,

send a message to the smart lock including:

the identifier of the virtual key; and

the first opening key depending on the challenge received and the information contained in the virtual key.

Virtual keys and smart locks are defined.

A smart lock integrated into an object allows the object to make “opening” decisions, that is to say to authorize access or use of the object. An object may contain one or more smart locks.

Note that in this description, the term “object” may represent a physical object, for example a car, or a virtual object, for example a piece of music or a service, for example a concierge service.

A virtual key is a system capable of exchanging information with smart locks for the purpose for the user (person, system, process) possessing the virtual key to obtain the right to access or use the object with which the smart lock is associated.

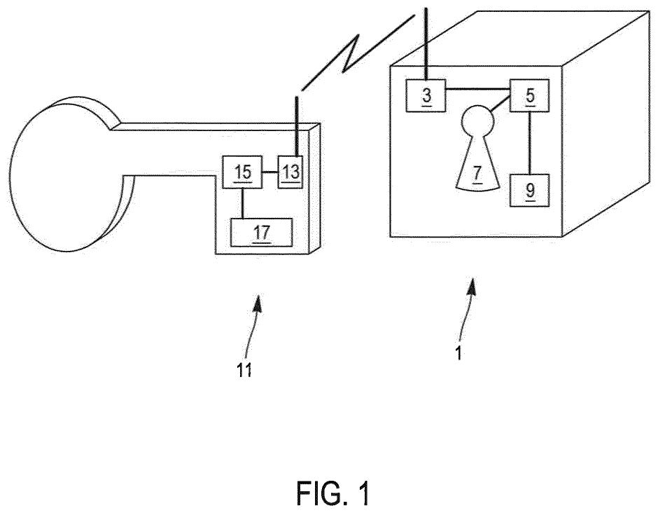

Referring to FIG. 1, the smart lock 1 comprises a digital communication means 3, a computer 5, a logic latch 7 to unlock access to the object or service and a storage memory 9.

The storage memory 9 contains an identifier of the lock Lock-ID, a key pair for asymmetric cryptography Klock-pub, Klock-private.

The user therefore has a digital device called virtual key 11 comprising a communication means 13 adapted to communicate with the communication means 3 of the smart lock 1, a computer 15 and a storage memory 17.

The storage memory 17 contains an identifier of the virtual key Key-ID, the identifier Lock-ID and the public key Klock-pub of the smart lock with which is associated the virtual key and a first information Kv1 obtained as the signature by the private key of the smart lock Klock-priv of the identifiers of the key virtual Key-ID and of the smart lock Lock-ID and of an arbitrary parameter Misc1.

The communication means 3, 13 communicate in particular using a short or medium range radio communication technology such as RFID, Bluetooth or WiFi.

In addition, the term ‘context’ defines any type of information intended to restrict or condition the right of access of a virtual key, such as the date, the time, the period of validity, the location, the number of requests for access, or limits on parameters of the request (the amount of a transaction for example).

The lock 7 of the smart lock 1 comprises 2 or 3 levels of access to the object or service associated with 2 or 3 levels of interaction between the virtual key and the user, a first level associated with an implicit interaction by simple communication between the means of communication of the virtual key and of the smart lock, a second level associated with an interaction with explicit validation of the user and a third optional level associated with a user identification.

These types of interactions specify how the carrier of a virtual key can implement it in order to obtain authorization to access or use an object. The first type of interaction, called “contactless” corresponds to an implicit access request, that is to say without intervention of the carrier of the virtual key; the dialogue between the virtual key and the smart lock can, however, be conditioned by the distance between these systems (use of a short or medium-range radio communication) or by other elements that do not assume any particular action of the carrier of the virtual key. A second type of interaction called “with carrier validation” requires as its name indicates a confirmation of the carrier of the virtual key, for example a click, a ‘swipe’, the press of a button, or the answer to a Turing test. The third type of interaction called “with carrier identification” requires the provision by the user of an identification element such as entering a PIN or the use of a biometric sensor. These types of interactions make it possible to choose and control the level of security required when requesting access or use. According to the requests, the same object may require the implementation of one or more types of more or less secure interactions.

Key and lock stored data are managed by an issuing system whose functions are to create and revoke smart locks and virtual keys. During the manufacture of the objects, during their distribution, or even later, the issuing system is used to create smart locks and to load them into the objects. The loading of a smart lock into an object is achieved by conventional means of management, and more particularly of injection of cryptographic data. The issuing system creates on-demand virtual keys, each key being created specifically for a smart lock designated in the creation request. It is also optionally possible to specify in the application the context of use of the virtual key (in the sense that the word ‘context’ has been defined previously) but also its carrier in order to restrict the conditions of implementation of the virtual key.

When created by the issuing system, the smart lock (at least the key pair) can itself be encrypted to allow distribution or installation in the object via an unsecured public network. This requires having previously equipped the objects or points of distribution and installation of smart locks of a key or a certificate for decryption. This key or certificate can be unique by object or common to a fleet of objects, depending on the desired compromise between securing and simplicity of the process of creation and distribution of smart locks.

Note R (for ‘Rights’) the desired usage context for a virtual key and fR a summary function chosen to summarize R almost unambiguously. For example, if the usage context R is described by an XML file whose format depends on the intended application and specific context data, it is possible to choose for fR a hash function, such as SHA2, applied to the XML file. Those skilled in the art will thus be able to define such a summary function regardless of the application envisaged, this summary function having the property of providing a result of invariant format and describing the context in an almost unambiguous manner, even if the format or parameters describing the context would evolve.

It is thus possible to request the issuing system to create a virtual key for a smart lock Lock-ID, a context summarized by fR(R), and a given user. Provided that these parameters are correctly defined and known by the issuing system and that the user has the appropriate permissions to obtain the delivery of this virtual key, the issuing system creates a virtual key containing the aforementioned information, namely:

A virtual key identifier Key-ID;

The identifier of the smart lock Lock-ID to which this key is linked;

Klock-pub, the public key of the smart lock with which the virtual key is associated

The first information Kv1 result of the signature by the private key Klock-priv of the parameters Lock-ID, Key-ID and Misc1, where Misc1 is an arbitrarily chosen parameter. The order of the parameters is not essential. Kv1 is used for “contactless” or “carrier validated” interactions;

An information HR obtained at the result of the signature by the private key Klock-priv the parameters Key-ID and fR(R). The HR information makes it possible to prove to the smart lock the authenticity of the rights (context) attached to the virtual key.

In an alternative embodiment, the two types of interaction can be differentiated by associating, for example, Kv1 with the implicit interaction and a second piece of information Kv2 with the interaction with validation of the carrier. In this case, Kv2 is calculated similarly to Kv1 but using a Misc2 parameter different from Misc1.

For the interaction with user authentication, a Kv3′ information is obtained by encrypting a Kv3 information with an encryption key Kpin, this information and this key being defined as follows: Kv3 information is calculated similarly to Kv1 by signing by the private key Klock-priv the parameters Lock-ID, Key-ID and Misc3, where Misc3 is a different parameter from Misc1, and Misc2, in the variant using this parameter, chosen arbitrarily. The encryption key Kpin is derived from a secret code linked to the user for whom the virtual key is created, for example a secret code that the user knows, or a secret code provided by a biometric sensor in case of successful identification of said user by this sensor. The derivation of the key Kpin is done by applying a hash function to at least said secret code, or Lock-ID and Key-ID as well to further limit the possibilities of fraudulent use and attack. In an embodiment where the user does not have such a secret code, Kv3′ is ignored.

When created by the issuing system, the virtual key (at least the information other than Lock-ID and Key-ID) may itself be encrypted in order to allow the distribution using a public network or non-secure channels. This requires having previously equipped carriers with a key or a certificate for decryption. This key or certificate will preferably be unique per carrier but may be present on several devices of the same user such as smartphones.

In an alternative embodiment, a strong authentication method such as those described in EP 2 347 541, the contents of which are fully incorporated herein by reference, is used so that a carrier and the transmission system share a key or an encryption certificate, in a safe and simple manner that remains secret for third parties.

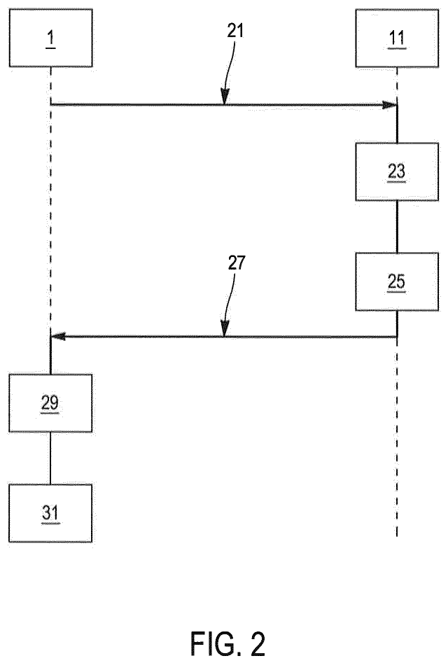

Access authorization or use of the object results from a dialogue between a smart lock associated with the object and a virtual key, this dialogue being defined by the protocol described below, FIG. 2.

In a first step 21, the smart lock provides an information packet containing:

The Lock-ID identifier;

A challenge Ch1 created by the smart lock for this authorization dialogue;

A proof calculated as the signature by the private key Klock-priv of an information related to the parameters challenge Ch1 and Lock-ID. For example, this information may be the result of a hash function of these two parameters. In an alternative embodiment where it is possible to propose a secure pairing mechanism between the system containing the virtual key and the one containing the smart lock, the parameters used to calculate the proof are supplemented with an identifier of the current session established between the communication means; there are different ways to achieve such pairing leading to the exchange of secrets to establish a secure session, such as an explicit confirmation from the user, or an implicit confirmation if the default pairing has not been revoked;

The type of interaction desired for authorization.

Upon receipt of this information, the system containing the user's virtual key(s) performs, at step 23, the following checks:

The system contains at least one virtual key for the received smart lock identifier and for the current context elements (for example, the current time). In an alternative embodiment where the system containing the virtual key has triggered the authorization request for this smart lock, this first check is redundant and can be omitted;

The signature is valid, that is, the system that created the proof had access to the private part of the key of the smart lock for which the system containing the virtual key has the public part.

The system containing the virtual key used for the authorization request then implements, step 25, the user the interaction request corresponding to the type requested by the smart lock or the authorization system of the object. The system containing the virtual key provides, step 27, an information packet containing:

The Key-ID identifier;

The HR information as well as elements of the context that would not be implicit in the context of the object (for example, an authorization period is not implicit);

A first opening key calculated as a hash function applied to the challenge and the data Kv1 if the type of interaction requested was “contactless”, or to the data Kv2 if the type of interaction requested was “with carrier validation”;

If the type of interaction requested was “with carrier identification”, a second opening key obtained by decrypting the data Kv3′ with an encryption key Kpin-local calculated similarly to Kpin using the secret code provided by the user (respectively, by a biometric sensor) for this authorization request.

Upon receipt of this information, the system containing the smart lock performs, step 29, the following checks:

HR corresponds to the contextual elements, implicit and provided. For this, the context parameters R are provided to the smart lock 1 or by the virtual key 11, and in this case the message of the virtual key 11 contains the entire context, either by the transmission system in a step preliminary initialization. The smart lock 1 then calculates fR(R)-local in a mode identical to fR(R) then signs fR(R)-local and Key-ID with its private key to obtain HR-local. The smart lock then verifies that HR-local is equal to the HR information received;

The first opening key is valid. This validation is performed in a similar way to HR validation. Thus, the smart lock 1 has received from the transmission system the Misc1, Misc2 and Misc3 parameters. It is therefore able to calculate a Kvi where i is equal to 1 or 2 and therefore able to calculate the first opening key to compare the result of the calculation with the first opening key received;

If the type of interaction requested was “with carrier identification”, the smart lock also verifies that the second opening key is valid by the same validation method implemented for the first opening key;

The information received is provided for the challenge associated with this authorization request.

Note that the system containing the virtual key cannot provide a valid second opening key without the user (respectively, the biometric sensor) providing the correct secret code for that user. This works without this system or the system containing the smart lock needing to know this secret code.

From a security standpoint for this mechanism, it must be ensured that the system containing the virtual key does not keep or expose this secret code after use.

In the alternative embodiment in which an opening key for the type of interaction “with validation of the carrier” is required, it must be ensured that this opening key is not provided without a real user interaction, in order to ensure the security of this mechanism.

From a security standpoint for this mechanism, it must be ensured that the data Kv1, Kv2 and Kv3′ are not exposed when the virtual key performs calculations using their plaintext version (decrypted) or if they are not stored in encrypted form in one embodiment.

Finally, from a security standpoint for this mechanism, it will be taken care that the private key is not exposed when the smart lock makes calculations using its version in clear text (decrypted) or if it is not stored in an encrypted manner.

The means to obtain these different guarantees in a more or less reliable and persistent way—such as: mobile application audit, mechanisms for verifying the security context of a mobile application, protected storage or execution means—are conventional techniques of computer security and contribute to the overall security of the embodiments.

The smart lock uses its private key to perform these checks. If all these checks are carried out successfully, the smart lock can confirm, step 31, to the object or the system containing it, the authorization of access or use for the benefit of the carrier of the virtual key. Otherwise, the authorization request fails.

In an alternative embodiment, if the authorization request fails, the authorization system containing the smart lock implements countermeasures to protect itself from attacks intended to circumvent it, such as:

If the first open key is valid but the second open key has been requested and is not valid, increment an error counter associated with the Key-ID identifier and, beyond a threshold, apply restrictions on authorization requests received for this identifier, such as a maximum number of requests, delays—possibly increasing—between two requests, or even a revocation of the virtual key;

If the required opening key(s) are valid but HR does not match the context elements, put the Key-ID identifier in a temporary or permanent revocation list;

If all the information is valid but calculated for a different challenge than the one created by the smart lock for the current authorization request (for example a challenge previously provided), put the Key-ID identifier in a temporary or permanent revocation list;

The system can also limit the number of authorization requests processed per unit of time to guard against brute force attacks on its private key, particularly if the specifications of the smart lock environment (CPU performance, size of the RAM or flash memory, etc.) impose to limit the size of the private key far below the recommendations of the state of the art in terms of security; and or

The system containing the smart lock can also on its own initiative request a more restrictive type of interaction than that required by the authorization system, particularly in the case of numerous requests for authorization concerning a smart lock.

In an alternative embodiment, the local authorization system contains a revocation list for temporarily or permanently denying requests associated with virtual keys. This list of revocation can be managed locally by a smart lock but also by the central authorization system.

In an alternative embodiment, the system containing the virtual key(s) implements countermeasures to protect the fraudulent use of the virtual keys with a “contactless” type of interaction. It can be to limit the number of requests per unit of time, to force a type of interaction more restrictive than the one requested, to keep a local list of challenges used and to implement restrictions in the event of a finding of a replay of a challenge.

In an alternative embodiment, particularly if the system containing the smart lock has limited performances, the data Kv1, Kv2, Kv3 and HR are calculated using hash functions applied to their respective parameters and to a secret information Klock associated with the smart lock, rather than a signature by the asymmetrical key Klock-priv. Thus, the verification of these data by the smart lock is done through a simple hash function instead of decryption by a public key.

Depending on the embodiment, the communication means may also consist of a wired connection such as, for example, a USB connection.

This method is applicable to an access control of an object such as, for example, a car in which a first access level is defined for opening the doors and a second level of access is defined for starting the engine.

It can also be used for controlling access to a service.

1. A digital method for controlling access to an object or service by a user, said access to said object or service being controlled by a smart lock access control device (1) comprising a digital communication means (3), a computer (5), a lock (7) for unlocking access to the object or service and a storage memory (9) containing an identifier of the smart lock (Lock-ID), a key pair for asymmetric cryptography (Klock-priv, Klock-pub) and the user having a digital device called virtual key (11) comprising a communication means (13) adapted to communicate with the communication means of the smart lock, a calculator (15) and a storage memory (17) containing an identifier of the virtual key (Key-ID), the identifier (Lock-ID) and the public key (Klock-pub) of the smart lock with which is associated the virtual key and a first information (Kv1) obtained as a result of the signature by the private key (Klock-priv) of the identifiers of the virtual key and of the smart lock (Key-ID, Lock-ID) and an arbitrary parameter (Misc1), the lock of the smart lock comprising at least two levels of access to the object or service associated with two levels of interaction between the virtual key and the user, a first level associated with an implicit interaction by simply having a communication between the communication means of the virtual key and of the smart lock and a second level associated with an interaction with explicit validation of the user, said method comprising:
sending by the smart lock to the virtual key a message comprising:
the identifier of the smart lock (Lock-ID);
a challenge (Ch1) created by the smart lock
the signature by the private key of the smart lock (Klock-priv) of information related to the identifier of the smart lock (Lock-ID) and challenge (Ch1); and
the level of interaction required among at least two levels of interaction;
verifying by the virtual key that the smart lock is known to it by comparison of the smart lock identifier received to that stored by the virtual key;
validating by the virtual key of the signature by using the public key of the smart lock (Klock-pub); and, if the validation is positive selecting and implementing the level of interaction received by the virtual key; and
after validation of the interaction by the virtual key sending a message by the virtual key to the smart lock comprising:
the identifier of the virtual key (Key-ID); and
a first opening key depending on the challenge received (Ch1) and the information (Kv1) contained in the virtual key; so that if the smart lock validates the opening key, it gives access to the object or service with the access level associated with the interaction level used.

2. The method according to claim 1, wherein the virtual key contains a second information (Kv2) constructed similarly as the first information (Kv1) but with an arbitrary parameter (Misc2) distinct from Misc1, each information being associated with a type of interaction.

3. The method according to claim 1, wherein a third level of access to the product or service is defined and associated with a level of interaction with identification of the carrier, and in that the virtual key further comprises a third piece of information (Kv3′) obtained by the encryption of a third piece of information (Kv3) constructed in the same way as the first item of information (Kv1) but with an arbitrary parameter (Misc3) distinct, the encryption being done with a key (Kpin) derived a secret code associated with the user, the method further comprising that, when interacting with the user, the virtual key calculates a decryption key (Kpin-local) in a manner similar to the encryption key (Kpin) and the message sent by the virtual key after the validation step of the interaction further comprises a second opening key obtained by decrypting the third encrypted information (Kv3′) by the decryption key (Kpin-local) and the smart lock also validates the second open key before allowing access to the product or service.

4. The method of claim 1, wherein the virtual key further comprises a context information (HR) obtained as a result of the signature of the identifier of the virtual key (Key-ID) and of a parameter (fR(R)) synthesizing the access rights associated with the virtual key with the private key of the smart lock (Klock-priv), this context information (HR) being transmitted by the virtual key to the smart lock so that the smart lock validates the context information (HR) before allowing access to the product or service.

5. The method of claim 4, wherein the parameter (fR(R)) is generated by a hash function (fR) having as input an XML file describing the context.

6. The method of claim 1, wherein the smart lock comprises a revocation list containing the identifiers of the virtual keys for which no access authorization is possible.

7. A non-transitory computer readable media having instructions stored thereon, that when executed by a processor, controls access to an object or service by a user, said access to said object or service being controlled by a smart lock access control device (1) comprising a digital communication means (3), a computer (5), a lock (7) for unlocking access to the object or service and a storage memory (9) containing an identifier of the smart lock (Lock-ID), a key pair for asymmetric cryptography (Klock-priv, Klock-pub) and the user having a digital device called virtual key (11) comprising a communication means (13) adapted to communicate with the communication means of the smart lock, a calculator (15) and a storage memory (17) containing an identifier of the virtual key (Key-ID), the identifier (Lock-ID) and the public key (Klock-pub) of the smart lock with which is associated the virtual key and a first information (Kv1) obtained as a result of the signature by the private key (Klock-priv) of the identifiers of the virtual key and of the smart lock (Key-ID, Lock-ID) and an arbitrary parameter (Misc1), the lock of the smart lock comprising at least two levels of access to the object or service associated with two levels of interaction between the virtual key and the user, a first level associated with an implicit interaction by simply having a communication between the communication means of the virtual key and of the smart lock and a second level associated with an interaction with explicit validation of the user, said instructions controlling access to the smart object comprising:
sending by the smart lock to the virtual key a message comprising:
the identifier of the smart lock (Lock-ID), a challenge (Ch1) created by the smart lock the signature by the private key of the smart lock (Klock-priv) of information related to the identifier of the smart lock (Lock-ID) and challenge (Ch1); and
the level of interaction required among at least two levels of interaction;
verifying by the virtual key that the smart lock is known to it by comparison of the smart lock identifier received to that stored by the virtual key;
validating by the virtual key of the signature by using the public key of the smart lock (Klock-pub); and, if the validation is positive selecting and implementing the level of interaction received by the virtual key; and
after validation of the interaction by the virtual key, sending a message by the virtual key to the smart lock comprising:
the identifier of the virtual key (Key-ID); and
a first opening key depending on the challenge received (Ch1) and the information (Kv1) contained in the virtual key; so that if the smart lock validates the opening key, it gives access to the object or service with the access level associated with the interaction level used.

8. The non-transitory computer readable storage media of claim 7, wherein the virtual key contains a second information (Kv2) constructed similarly as the first information (Kv1) but with an arbitrary parameter (Misc2) distinct from Misc1, each information being associated with a type of interaction.

9. The non-transitory computer readable storage media of claim 7, wherein a third level of access to the product or service is defined and associated with a level of interaction with identification of the carrier, and in that the virtual key further comprises a third piece of information (Kv3′) obtained by the encryption of a third piece of information (Kv3) constructed in the same way as the first item of information (Kv1) but with an arbitrary parameter (Misc3) distinct, the encryption being done with a key (Kpin) derived a secret code associated with the user, the method further comprising that, when interacting with the user, the virtual key calculates a decryption key (Kpin-local) in a manner similar to the encryption key (Kpin) and the message sent by the virtual key after the validation step of the interaction further comprises a second opening key obtained by decrypting the third encrypted information (Kv3′) by the decryption key (Kpin-local) and the smart lock also validates the second open key before allowing access to the product or service.

10. The non-transitory computer readable storage media of claim 7, wherein the virtual key further comprises a context information (HR) obtained as a result of the signature of the identifier of the virtual key (Key-ID) and of a parameter (fR(R)) synthesizing the access rights associated with the virtual key with the private key of the smart lock (Klock-priv), this context information (HR) being transmitted by the virtual key to the smart lock so that the smart lock validates the context information (HR) before allowing access to the product or service.

11. The non-transitory computer readable storage media of claim 10 wherein the parameter (fR(R)) is generated by a hash function (fR) having as input an XML file describing the context.

12. The non-transitory computer readable storage media of claim 7, wherein the smart lock comprises a revocation list containing the identifiers of the virtual keys for which no access authorization is possible.

13. A digital smart lock access control device (1) for controlling access to an object or service by a user, comprising a digital communication means (3), a computer (5), a lock (7) for unlocking the access to the object or service and a storage memory (9) containing an identifier of the smart lock (Lock-ID), a key pair for asymmetric cryptography (Klock-pub, Klock-priv), and being adapted to communicate with a digital device called virtual key (11) comprising a communication means (13) adapted to communicate with the communication means of the smart lock, a computer (15) and a storage memory (17) containing an identifier of the virtual key (Key-ID), the identifier (Lock-ID) and the public key (Klock-pub) of the smart lock to which the virtual key is associated and a first information (Kv1) obtained as a result of the signature by the private key (Klock-priv) of identifiers of the virtual key and of the smart lock (Key-ID, Lock-ID) and of an arbitrary parameter (Misc1), the lock of the smart lock comprising at least 2 levels of access to the object or service associated with 2 levels of interaction between the virtual key and the user, a first level associated with an implicit interaction by simple communication of the means of communication of the virtual key and of the smart lock and a second level associated with an interaction with explicit validation by the user, said access control device to:
send to the virtual key a message including:
the identifier of the smart lock (Lock-ID);
a challenge (Ch1) created by the smart lock;
the signature by the private key of the smart lock (Klock-priv) information related to the identifier of the smart lock (Lock-ID) and challenge (Ch1); and
the level of interaction required among at least two levels of interaction;
receive a message from the virtual key including:
the identifier of the virtual key (Key-ID); and
a first opening key depending on the challenge received (Ch1) and the information (Kv1) contained in the virtual key; and
if the opening key is validated, give access to the object or service with the access level associated with the interaction level used.

14. A virtual key adapted to communicate with a digital smart lock access control device (1) comprising a digital communication means (3), a computer (5), a lock (7) for unlocking the access to the object or service and a storage memory (9) containing an identifier of the smart lock (Lock-ID), a key pair for asymmetric cryptography (Klock-pub, Klock-priv), said virtual key (11) comprising a communication means (13) adapted to communicate with the communication means of the smart lock, a computer (15) and a storage memory (17) containing an identifier of the virtual key (Key-ID), the identifier (Lock-ID) and the public key (Klock-pub) of the smart lock to which the virtual key is associated and a first piece of information (Kv1) obtained as a result of the signature with the private key (Klock-priv) of identifiers of the virtual key and of the smart lock (Key-ID, Lock-ID) and of an arbitrary parameter (Misc1), the lock of the smart lock comprising at least 2 levels of access to the object or service associated with 2 levels of interaction between the virtual key and the user, a first level associated with an implicit interaction by simple communication of the means of communication of the virtual key and of the smart lock and a second level associated with an interaction with explicit validation of the user, said virtual key to:
receive from the smart lock a message including:
the identifier of the smart lock (Lock-ID);
challenge (Ch1) created by the smart lock;
the signature by the private key of the smart lock (Klock-priv) of an information related to the identifier of the smart lock (Lock-ID) and the challenge (Ch1); and
the level of interaction required among at least two levels of interaction;
verify that the smart lock is known to it by comparison of the smart lock identifier received to that stored by the virtual key;
validate the signature by using the public key of the smart lock (Klock-pub); and, if the validation is positive, select and implement the level of interaction received by the virtual key; and
after validation of the interaction, send a message to the smart lock including:
the identifier of the virtual key (Key-ID); and
a first opening key depending on the challenge received (Ch1) and the information (Kv1) contained in the virtual key.
